(19) United States
(12) Patent Application Publication
(10) Pub. No.: US 2018/0157351 A1
(43) Pub. Date: Jun. 7, 2018

(54) Display Device having Light Receiving Application

(71) Applicant: Everlight Electronics Co., Ltd., New Taipei City (TW)

(72) Inventor: Ming-Jing LEE, New Taipei City (TW)

(73) Assignee: Everlight Electronics Co., Ltd., New Taipei City (TW)

(21) Appl. No.: 15/827,836

(22) Filed: Nov. 30, 2017

Related U.S. Application Data
(60) Provisional application No. 62/429,084, filed on Dec. 2, 2016.

(51) Int. Cl. G06F 3/042; G09G 3/32

(52) U.S. Cl. CPC G06F 3/042; G09G 3/32

(57) ABSTRACT

A display device is provided and includes a light transmissive plate, a substrate, and a plurality of light-emitting units, which are disposed between the substrate and the light transmissive plate. Each of the light emitting units includes of a plurality of light emitting diodes, any one of which can be used as a light-detecting element. Therefore, whenever the display device is at displaying or full black state, the display device can have touch control function, object detection function and/or signal transmission function.

### CROSS-REFERENCES TO RELATED APPLICATIONS

This application claims benefits of U.S. Provisional Application No. 62/429,084 filed on Dec. 2, 2016, which is hereby incorporated by reference in its entirety.

### BACKGROUND OF THE INVENTION

### Field of the Invention

The present invention relates to a display device, and particularly, relates to a display device using light emitting diodes as light emitting units and a light detecting element.

### Descriptions of the Related Art

Light emitting diodes (LEDs) have been developed for several decades. In addition to being used as indicator lamps, lighting sources, light sources of backlight modules, outdoor large-scale signboards or the like, LEDs are now developing to be used in displays of electronic devices. That is, by means of the semiconductor lithography, LED chips can be downsized to the micrometer scale, e.g., close to or smaller than the pixel size of displays. Then the miniaturized LED (micro LEDs) chips are arranged into an array to form a display. Each pixel of the display may comprise one or more micro LED chips, and this kind of display may be called a micro LED display.

When being applied in smartphones, notebook computers, tablet computers or the like products, such an LED display usually necessitates use of an additional touch module to achieve the touch function. On the other hand, if a floating touch (i.e., an object such as a finger can be sensed by the display without touching the display), an object detection or an optical signal transmission function is desired in the display, corresponding additional parts shall be installed. Such parts will increase the thickness of the display and probably also increase the cost of the display.

Accordingly, how to achieve the functions such as the touch function, the object detection function and/or the optical signal transmission function in the LED display without increasing the number of parts (or only slightly increasing the number of parts) is a research objective in the art.

### SUMMARY OF THE INVENTION

An objective of the present invention is to provide a display device which, besides using LEDs as light emitting elements, also using the LED as a light-detecting element to achieve such functions as the touch function, the object detection function and/or the optical signal transmission function. Another objective of the present invention is to provide a display device which can achieve such functions as the touch function, the object detection function and/or the optical signal transmission function at a full black state of the display device.

To achieve the aforesaid objective, a display device provided in the present invention comprises a light transmissive plate, a substrate and a plurality of light emitting units. The light emitting units are disposed between the substrate and the light transmissive plate and electrically connected to the substrate. Each of the light emitting units comprises a plurality of light emitting diodes, in which at least one of the light-emitting diodes serves as a light-detecting element.

On the other hands, the display device provided in the present invention may comprises the following embodiments:

1. A display device having light receiving application, comprising: a light transmissive plate; a substrate; and a plurality of light-emitting units, disposed between the substrate and the light transmissive plate, wherein each said light-emitting unit comprises a plurality of light-emitting diodes, in which any of the light-emitting diodes serves as a light-detecting element.

The display device further includes a control circuit disposed on the substrate and electrically connected to each of the plurality of light emitting diodes, wherein the control circuit is either configured to apply a first control signal to each of at least a subset of the light emitting diodes to emit light during at least a first time period and to apply a second control signal to each of the subset of the light emitting diodes to detect an electrical signal generated by each of the subset of the light emitting diodes in response to being irradiated by light during a second time period, or the control circuit is configured to apply a first control signal to each of at least a first subset of the light emitting diodes to emit light and at the same time to apply a second control signal to each of a second subset of the light emitting diodes to detect an electrical signal generated by each of the second subset of the light emitting diodes in response to being irradiated by light.

2. The display device of embodiment 1, wherein the light-emitting diodes of each said light-emitting diode serve as both light-emitting elements and the light-detecting elements for each other.

3. The display device of embodiment 1, wherein light emitted by the light-emitting diodes has wavelengths falling within a wavelength range of visible light, and the visible light light-emitting diodes serve as light-emitting elements and the light-detecting elements for each other.

4. The display device of embodiment 1, wherein light emitted by the light-emitting diodes has wavelengths falling within both a wavelength range of visible light and a wavelength range of invisible light, and the visible light light-emitting diodes and the invisible-light-emitting diodes serve as light-emitting elements and the light-detecting elements for each other.

5. The display device of embodiment 1, wherein the light-emitting diodes include a red light-emitting diode, a green light-emitting diode, and a blue light-emitting diode, in which the light-emitting diodes serve as light-emitting elements and the light-detecting element for each other.

6. The display device of embodiment 1, wherein the light-emitting diodes include a red light-emitting diode, a green light-emitting diode, a blue light-emitting diode, and an invisible light light-emitting diode, in which the light-emitting diodes serve as light-emitting elements and the light-detecting element for each other.

7. The display device of embodiment 1, wherein the light-emitting diodes include a red light-emitting diode, a green light-emitting diode, a blue light-emitting diode, and an infrared light-emitting diode, in which the light-emitting diodes serve as light-emitting elements and the light-detecting element for each other.

8. The display device of embodiment 1, wherein the light-emitting diodes include a red light-emitting diode, a green light-emitting diode, a blue light-emitting diode, and an ultraviolet light-emitting diode, in which the light-emitting diodes serve as light-emitting elements and the light-detecting element for each other.

9. The display device of embodiment 1, wherein the light-emitting diodes include a red light-emitting diode, a green light-emitting diode, a blue light-emitting diode, an infrared light-emitting diode, and an ultraviolet light-emitting diode, in which the light-emitting diodes serve as light-emitting elements and the light-detecting element for each other.

10. The display device of embodiment 1, wherein the light-emitting diodes of the light-emitting units serves as light-emitting elements and the light-detecting elements for each other.

11. The display device of embodiment 1, wherein the light-emitting diodes are configured to detect a light source provided externally.

12. The display device of embodiment 1, which has a use of a touch display device.

13. The display device of embodiment 1, wherein when the display device blacks out, the display device still has a use of a touch display device.

14. The display device of embodiment 1, which has a use of detecting objects.

15. The display device of embodiment 1, wherein when the display device blacks out, the display device still has a use of detecting objects.

16. The display device of embodiment 1, which has a use of transmitting signals.

17. The display device of embodiment 1, wherein when the display device blacks out, the display device still has a use of transmitting signals.

18. The display device of embodiment 1, wherein the light transmissive plate is made of a light-transmitting material, and is a glass screen, a plastic screen, a sapphire screen, or a flexible screen.

19. The display device of embodiment 1, wherein the substrate is an opaque substrate, and is a printed circuit substrate, a ceramic substrate, a semiconductor substrate, a plastic substrate, and a flexible substrate.

20. The display device of embodiment 1, wherein the light-emitting diodes comprise a plurality of light-emitting diode chips.

21. The display device of embodiment 1, wherein the light-emitting diodes are a plurality of light-emitting diode chips.

22. The display device of embodiment 1, wherein the light-emitting diodes comprise a nitride semiconductor material.

23. The display device of embodiment 1, wherein the light-emitting diodes comprise a gallium nitride (GaN) semiconductor material.

24. The display device of embodiment 1, wherein the light-emitting diodes comprise a gallium arsenide (GaAs) semiconductor material.

25. The display device of embodiment 1, wherein the light-emitting diodes comprise a gallium phosphide (GaP) semiconductor material.

26. The display device of embodiment 1, wherein the light-emitting diodes comprising silicone (Si) semiconductor material.

27. The display device of embodiment 1, further comprising: a control circuit, electrically connected to the light-emitting diodes, respectively, for controlling the light-emitting diodes to emit light, and serving to detect light received by the light-emitting diodes.

28. The display device of embodiment 1, wherein in each said light-emitting unit, the light-emitting diode having the largest light-emitting wavelength serves to emit a light beam, and the light-emitting diode having the smallest light-emitting wavelength smallest serves to detect a light beam.

29. The display device of embodiment 1, wherein in each said light-emitting unit, the light-emitting diode having the smallest light-emitting wavelength serves to emit a light beam, and the light-emitting diode having the largest light-emitting wavelength serves to detect a light beam.

30. The display device of embodiment 1, wherein in each said light-emitting unit, the light-emitting diodes having the smallest and largest light-emitting wavelengths serve to emit light beams, and the light-emitting diodes having intermediate light-emitting wavelengths serve to detect light beams.

31. The display device of embodiment 1, wherein in each said light-emitting unit, the light-emitting diode having the largest light-emitting wavelength serves to emit a light beam, the remaining light-emitting diodes serves to detect light beam.

32. The display device of embodiment 1, wherein in each said light-emitting unit, the light-emitting diode having the smallest light-emitting wavelength serves to emit a light beam, the remaining light-emitting diodes serves to detect light beam.

33. The display device of embodiment 1, wherein in one said light-emitting unit, the light-emitting diode having the largest light-emitting wavelength serves to emit a light beam, and in another said light-emitting unit, the light-emitting diode having the smallest light-emitting wavelength smallest serves to detect a light beam.

34. The display device of embodiment 1, wherein in one said light-emitting unit, the light-emitting diode having the smallest light-emitting wavelength serves to emit a light beam, and in another said light-emitting unit, the light-emitting diode having the largest light-emitting wavelength serves to detect a light beam.

35. The display device of embodiment 1, wherein in one said light-emitting unit, the light-emitting diodes having the smallest and largest light-emitting wavelengths serve to emit light beams, and in another said light-emitting unit, the light-emitting diodes having intermediate light-emitting wavelengths serve to detect light beams.

36. The display device of embodiment 1, wherein in one said light-emitting unit, the light-emitting diode having the largest light-emitting wavelength serves to emit a light beam, and in another light-emitting unit, all of the light-emitting diodes serve to detect a light beam.

37. The display device of embodiment 1, wherein in one said light-emitting unit, the light-emitting diode having the smallest light-emitting wavelength serves to emit a light beam, and in another light-emitting unit, all of the light-emitting diodes serve to detect a light beam.

38. The display device of embodiment 1, wherein in one said light-emitting unit, at least one light-emitting diode serves to emit a light beam, and in another said light-emitting unit, at least one light-emitting diode serves to detect a light beam.

39. The display device of embodiment 1, wherein in one said light-emitting unit, all of the light-emitting diodes serve to emit a light beam, and in another light-emitting unit, all of the light-emitting diodes serve to detect a light beam.

40. The display device of embodiment 1, which is a touch panel.

41. The display device of embodiment 1, which is a shooter game display.

42. The display device of embodiment 1, which is a trap-shooting display or a writing board display.

43. The display device of embodiment 1, further comprising: a control circuit, for controlling the light-emitting diodes by means of pulse width modulation (PWM).

44. A display device, comprising: a light transmissive plate, configured to be touched by an object; a substrate; and a plurality of light-emitting units, disposed between the substrate and the light transmissive plate, wherein each said light-emitting unit comprises a plurality of light-emitting diodes, in which, one said light-emitting diode emits a first light beam, the first light beam facing the light transmissive plate and casted to the exterior, and reflected back as a second light beam by the object, in which, another said light-emitting diode serves to detect the second light beam, and output an electric signal, a control circuit, receiving the electric signal, and calculating a site on the light transmissive plate where the object is touching.

45. The display device of embodiment 44, wherein the light-emitting diodes of each said light-emitting diode serve as light-emitting elements and light-detecting elements for each other.

46. The display device of embodiment 44, wherein light emitted by the light-emitting diodes has wavelengths falling within a wavelength range of visible light, and the visible light light-emitting diodes serve as light-emitting elements and the light-detecting elements for each other.

47. The display device of embodiment 44, wherein light emitted by the light-emitting diodes has wavelengths falling within both a wavelength range of visible light and a wavelength range of invisible light, and the visible light light-emitting diodes and the invisible-light-emitting diodes serve as light-emitting elements and the light-detecting elements for each other.

48. The display device of embodiment 44, wherein the light-emitting diodes include a red light-emitting diode, a green light-emitting diode, and a blue light-emitting diode, in which the light-emitting diodes serve as light-emitting elements and the light-detecting element for each other.

49. The display device of embodiment 44, wherein the light-emitting diodes include a red light-emitting diode, a green light-emitting diode, and a blue light-emitting diode, an invisible light light-emitting diode, in which the light-emitting diodes serve as light-emitting elements and the light-detecting element for each other.

50. The display device of embodiment 44, wherein the light-emitting diodes include a red light-emitting diode, a green light-emitting diode, and a blue light-emitting diode, an infrared light-emitting diode, in which the light-emitting diodes serve as light-emitting elements and the light-detecting element for each other.

51. The display device of embodiment 44, wherein the light-emitting diodes include a red light-emitting diode, a green light-emitting diode, and a blue light-emitting diode, an ultraviolet light-emitting diode, in which the light-emitting diodes serve as light-emitting elements and the light-detecting element for each other.

52. The display device of embodiment 44, wherein the light-emitting diodes include a red light-emitting diode, a green light-emitting diode, and a blue light-emitting diode, an infrared light-emitting diode, an ultraviolet light-emitting diode, in which the light-emitting diodes serve as light-emitting elements and the light-detecting element for each other.

53. The display device of embodiment 44, wherein the light-emitting diodes of the light-emitting units serves as light-emitting elements and the light-detecting elements for each other.

54. The display device of embodiment 44, wherein the light-emitting diodes are configured to detect a light source provided externally.

55. The display device of embodiment 44, which has a use of a touch display device.

56. The display device of embodiment 44, wherein when the display device blacks out, the display device still has a use of a touch display device.

57. The display device of embodiment 44, which has a use of detecting objects.

58. The display device of embodiment 44, wherein when the display device blacks out, the display device still has a use of detecting objects.

59. The display device of embodiment 44, which has a use of transmitting signals.

60. The display device of embodiment 44, wherein when the display device blacks out, the display device still has a use of transmitting signals.

61. The display device of embodiment 44, wherein the light transmissive plate is made of a light-transmitting material, and is a glass screen, a plastic screen, a sapphire screen, or a flexible screen.

62. The display device of embodiment 44, wherein the substrate is an opaque substrate, and is a printed circuit substrate, a ceramic substrate, a semiconductor substrate, a plastic substrate, and a flexible substrate.

63. The display device of embodiment 44, wherein the light-emitting diodes comprise a plurality of light-emitting diode chips.

64. The display device of embodiment 44, wherein the light-emitting diodes are a plurality of light-emitting diode chips.

65. The display device of embodiment 44, wherein the light-emitting diodes comprise a nitride semiconductor material.

66. The display device of embodiment 44, wherein the light-emitting diodes comprise a gallium nitride (GaN) semiconductor material.

67. The display device of embodiment 44, wherein the light-emitting diodes comprise a gallium arsenide (GaAs) semiconductor material.

68. The display device of embodiment 44, wherein the light-emitting diodes comprise a gallium phosphide (GaP) semiconductor material.

69. The display device of embodiment 44, wherein the light-emitting diodes comprising silicone (Si) semiconductor material.

70. The display device of embodiment 44, wherein the control circuit electrically connected to the light-emitting diodes, respectively, for controlling the light-emitting diodes to emit light, and serving to detect light received by the light-emitting diodes.

71. The display device of embodiment 44, wherein in each said light-emitting unit, the light-emitting diode having the largest light-emitting wavelength serves to emit a light beam, and the light-emitting diode having the smallest light-emitting wavelength smallest serves to detect a light beam.

72. The display device of embodiment 44, wherein in each said light-emitting unit, the light-emitting diode having the smallest light-emitting wavelength serves to emit a light beam, and the light-emitting diode having the largest light-emitting wavelength serves to detect a light beam.

73. The display device of embodiment 44, wherein in each said light-emitting unit, the light-emitting diodes having the smallest and largest light-emitting wavelengths serve to emit light beams, and the light-emitting diodes having intermediate light-emitting wavelengths serve to detect light beams.

74. The display device of embodiment 44, wherein in each said light-emitting unit, the light-emitting diode having the largest light-emitting wavelength serves to emit a light beam, the remaining light-emitting diodes serves to detect light beam.

75. The display device of embodiment 44, wherein in each said light-emitting unit, the light-emitting diode having the smallest light-emitting wavelength serves to emit a light beam, the remaining light-emitting diodes serves to detect light beam.

76. The display device of embodiment 44, wherein in one said light-emitting unit, the light-emitting diode having the largest light-emitting wavelength serves to emit a light beam, and in another said light-emitting unit, the light-emitting diode having the smallest light-emitting wavelength smallest serves to detect a light beam.

77. The display device of embodiment 44, wherein in one said light-emitting unit, the light-emitting diode having the smallest light-emitting wavelength serves to emit a light beam, and in another said light-emitting unit, the light-emitting diode having the largest light-emitting wavelength serves to detect a light beam.

78. The display device of embodiment 44, wherein in one said light-emitting unit, the light-emitting diodes having the smallest and largest light-emitting wavelengths serve to emit light beams, and in another said light-emitting unit, the light-emitting diodes having intermediate light-emitting wavelengths serve to detect light beams.

79. The display device of embodiment 44, wherein in one said light-emitting unit, the light-emitting diode having the largest light-emitting wavelength serves to emit a light beam, and in another light-emitting unit, all of the light-emitting diodes serve to detect a light beam.

80. The display device of embodiment 44, wherein in one said light-emitting unit, the light-emitting diode having the smallest light-emitting wavelength serves to emit a light beam, and in another said light-emitting unit, all of the light-emitting diode serve to detect a light beam.

81. The display device of embodiment 44, wherein in one said light-emitting unit, at least one light-emitting diode serves to emit a light beam, and in another said light-emitting unit, at least one light-emitting diode serves to detect a light beam.

82. The display device of embodiment 44, wherein in one said light-emitting unit, all of the light-emitting diodes serve to emit a light beam, and in another light-emitting unit, all of the light-emitting diodes serve to detect a light beam.

83. The display device of embodiment 44, which is a touch panel.

84. The display device of embodiment 44, which is a shooter game display.

85. The display device of embodiment 44, which is a trap-shooting display.

86. The display device of embodiment 44, which is a writing board display.

87. The display device of embodiment 44, wherein the control circuit for controlling the light-emitting diodes by means of pulse width modulation (PWM).

88. A display device, comprising: a light transmissive plate, for displaying a scene, and having at least one function option; a substrate; and a plurality of light-emitting units, disposed between the substrate and the light transmissive plate, wherein each said light-emitting unit comprises a plurality of light-emitting diodes, in which, at least one said light-emitting diode serves to detect a light beam casted in from the exterior and output an electric signal, a control circuit, for receiving the electric signal, calculating a site where the external light beam is casted on the scene, and performing the function option located in the site of the scene accordingly.

89. The display device of embodiment 88, wherein the light-emitting diodes of each said light-emitting diode serve as light-emitting elements and light-detecting elements for each other.

90. The display device of embodiment 88, wherein light emitted by the light-emitting diodes has wavelengths falling within a wavelength range of visible light, and the visible light light-emitting diodes serve as light-emitting elements and the light-detecting elements for each other.

91. The display device of embodiment 88, wherein light emitted by the light-emitting diodes has wavelengths falling within both a wavelength range of visible light and a wavelength range of invisible light, and the visible light light-emitting diodes and the invisible-light-emitting diodes serve as light-emitting elements and the light-detecting elements for each other.

92. The display device of embodiment 88, wherein the light-emitting diodes include a red light-emitting diode, a green light-emitting diode, and a blue light-emitting diode, in which the light-emitting diodes serve as light-emitting elements and the light-detecting element for each other.

93. The display device of embodiment 88, wherein the light-emitting diodes include a red light-emitting diode, a green light-emitting diode, and a blue light-emitting diode, an invisible light light-emitting diode, in which the light-emitting diodes serve as light-emitting elements and the light-detecting element for each other.

94. The display device of embodiment 88, wherein the light-emitting diodes include a red light-emitting diode, a green light-emitting diode, and a blue light-emitting diode, an infrared light-emitting diode, in which the light-emitting diodes serve as light-emitting elements and the light-detecting element for each other.

95. The display device of embodiment 88, wherein the light-emitting diodes include a red light-emitting diode, a green light-emitting diode, and a blue light-emitting diode, an ultraviolet light-emitting diode, in which the light-emitting diodes serve as light-emitting elements and the light-detecting element for each other.

96. The display device of embodiment 88, wherein the light-emitting diodes include a red light-emitting diode, a green light-emitting diode, and a blue light-emitting diode, an infrared light-emitting diode, an ultraviolet light-emitting diode, in which the light-emitting diodes serve as light-emitting elements and the light-detecting element for each other.

97. The display device of embodiment 88, wherein the light-emitting diodes of the light-emitting units serves as light-emitting elements and the light-detecting elements for each other.

98. The display device of embodiment 88, wherein the light-emitting diodes are configured to detect a light source provided externally.

99. The display device of embodiment 88, which has a use of a touch display device.

100. The display device of embodiment 88, wherein when the display device blacks out, the display device still has a use of a touch display device.

101. The display device of embodiment 88, which has a use of detecting objects.

102. The display device of embodiment 88, wherein when the display device blacks out, the display device still has a use of detecting objects.

103. The display device of embodiment 88, which has a use of transmitting signals.

104. The display device of embodiment 88, wherein when the display device blacks out, the display device still has a use of transmitting signals.

105. The display device of embodiment 88, wherein the light transmissive plate is made of a light-transmitting material, and is a glass screen, a plastic screen, a sapphire screen, or a flexible screen.

106. The display device of embodiment 88, wherein the substrate is an opaque substrate, and is a printed circuit substrate, a ceramic substrate, a semiconductor substrate, a plastic substrate, and a flexible substrate.

107. The display device of embodiment 88, wherein the light-emitting diodes comprise a plurality of light-emitting diode chips.

108. The display device of embodiment 88, wherein the light-emitting diodes are a plurality of light-emitting diode chips.

109. The display device of embodiment 88, wherein the light-emitting diodes comprise a nitride semiconductor material.

110. The display device of embodiment 88, wherein the light-emitting diodes comprise a gallium nitride (GaN) semiconductor material.

111. The display device of embodiment 88, wherein the light-emitting diodes comprise a gallium arsenide (GaAs) semiconductor material.

112. The display device of embodiment 88, wherein the light-emitting diodes comprise a gallium phosphide (GaP) semiconductor material.

113. The display device of embodiment 88, wherein the light-emitting diodes comprising silicone (Si) semiconductor material.

114. The display device of embodiment 88, wherein the control circuit electrically connected to the light-emitting diodes, respectively, for controlling the light-emitting diodes to emit light, and serving to detect light received by the light-emitting diodes.

115. The display device of embodiment 88, wherein in each said light-emitting unit, the light-emitting diode having the largest light-emitting wavelength serves to emit a light beam, and the light-emitting diode having the smallest light-emitting wavelength smallest serves to detect a light beam.

116. The display device of embodiment 88, wherein in each said light-emitting unit, the light-emitting diode having the smallest light-emitting wavelength serves to emit a light beam, and the light-emitting diode having the largest light-emitting wavelength serves to detect a light beam.

117. The display device of embodiment 88, wherein in each said light-emitting unit, the light-emitting diodes having the smallest and largest light-emitting wavelengths serve to emit light beams, and the light-emitting diodes having intermediate light-emitting wavelengths serve to detect light beams.

118. The display device of embodiment 88, wherein in each said light-emitting unit, the light-emitting diode having the largest light-emitting wavelength serves to emit a light beam, the remaining light-emitting diodes serves to detect light beam.

119. The display device of embodiment 88, wherein in each said light-emitting unit, the light-emitting diode having the smallest light-emitting wavelength serves to emit a light beam, the remaining light-emitting diodes serves to detect light beam.

120. The display device of embodiment 88, wherein in one said light-emitting unit, the light-emitting diode having the largest light-emitting wavelength serves to emit a light beam, and in another said light-emitting unit, the light-emitting diode having the smallest light-emitting wavelength smallest serves to detect a light beam.

121. The display device of embodiment 88, wherein in one said light-emitting unit, the light-emitting diode having the smallest light-emitting wavelength serves to emit a light beam, and in another said light-emitting unit, the light-emitting diode having the largest light-emitting wavelength serves to detect a light beam.

122. The display device of embodiment 88, wherein in one said light-emitting unit, the light-emitting diodes having the smallest and largest light-emitting wavelengths serve to emit light beams, and in another said light-emitting unit, the light-emitting diodes having intermediate light-emitting wavelengths serve to detect light beams.

123. The display device of embodiment 88, wherein in one said light-emitting unit, the light-emitting diode having the largest light-emitting wavelength serves to emit a light beam, and in another light-emitting unit, all of the light-emitting diodes serve to detect a light beam.

124. The display device of embodiment 88, wherein in one said light-emitting unit, the light-emitting diode having the smallest light-emitting wavelength serves to emit a light beam, and in another said light-emitting unit, all of the light-emitting diode serve to detect a light beam.

125. The display device of embodiment 88, wherein in one said light-emitting unit, at least one light-emitting diode serves to emit a light beam, and in another said light-emitting unit, at least one light-emitting diode serves to detect a light beam.

126. The display device of embodiment 88, wherein in one said light-emitting unit, all of the light-emitting diodes serve to emit a light beam, and in another light-emitting unit, all of the light-emitting diodes serve to detect a light beam.

127. The display device of embodiment 88, which is a touch panel.

128. The display device of embodiment 88, which is a shooter game display.

129. The display device of embodiment 88, which is a trap-shooting display.

130. The display device of embodiment 88, which is a writing board display.

131. The display device of embodiment 88, wherein the control circuit for controlling the light-emitting diodes by means of pulse width modulation (PWM).

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a display device according to a preferred embodiment of the present invention.

FIG. 1B is a functional block diagram of the display device according to the preferred embodiment of the present invention.

FIGS. 2A-2D are schematic views of the display device according to the preferred embodiment of the present invention in use.

FIGS. 3A-3C are schematic views of a display device according to another preferred embodiment of the present invention in use.

FIGS. 4A-4C schematically illustrate exemplary configurations of the control circuit and the LED array according to embodiments of the present invention.

### DESCRIPTION OF THE PREFERRED EMBODIMENT

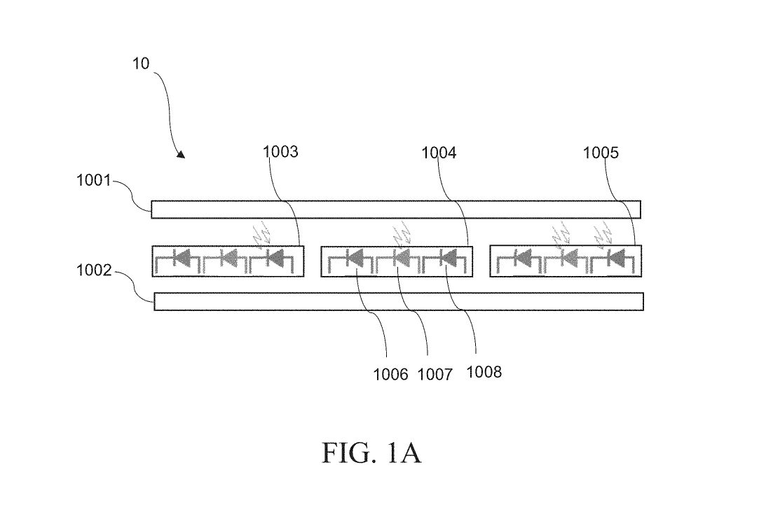

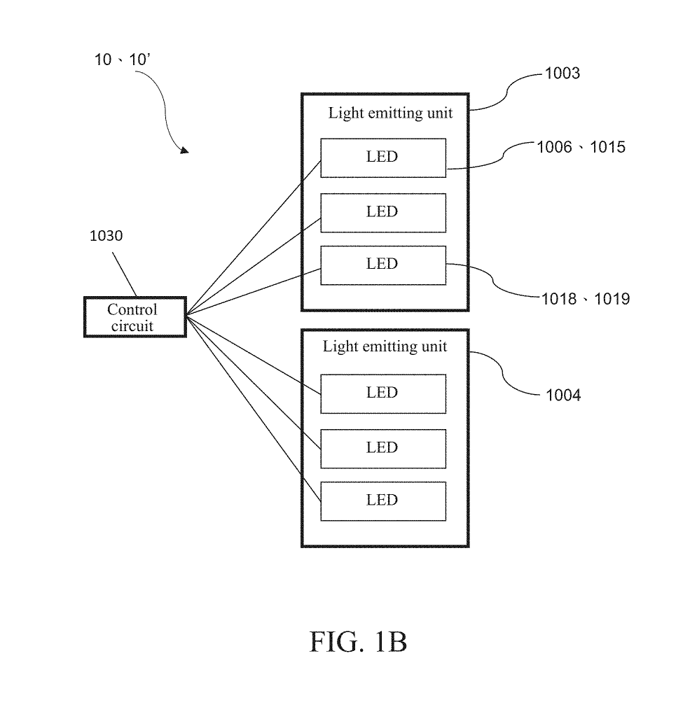

Please refer to FIG. 1A, which depicts a schematic view of elements of a display device 10 according to a preferred embodiment of the present invention. Besides displaying images, the display device 10 can further detect light to achieve such functions as the touch function, the object detection function and/or the signal transmission function.

The display device 10 may comprise a light transmissive plate 1001, a substrate 1002 and a plurality of light emitting units 1003˜1005 (taking three light emitting units as an example). The light transmissive plate 1001 is light transmissive so that light emitted by the light emitting units 1003˜1005 can pass through the light transmissive plate 1001; and additionally, the light transmissive plate 1001 may be of a type known in the art such as a glass screen, a plastic screen, a sapphire screen, or a flexible screen.

The substrate 1002 may be an opaque and reflective substrate, so a part of light emitted by the light emitting units 1003˜1005 can be reflected by the substrate 1002 to travel towards the light transmissive plate 1001; additionally, the substrate 1002 may be of a type known in the art such as a printed circuit substrate, a ceramic substrate, a semiconductor substrate, a plastic substrate, and a flexible substrate. The substrate 1002 may also comprise a conductive wiring layer, pads or connectors (not shown) so that the light emitting units 1003˜1005 can be easily disposed on the substrate 1002 and electrically connected with each other. Further, the substrate 1002 and the light transmissive plate 1001 are disposed to be apart from each other.

The light emitting units 1003˜1005 are disposed between the substrate 1002 and the light transmissive plate 1001, and may be disposed or formed on the substrate 1002. Additionally, the light emitting units 1003˜1005 may be spaced apart from (or may be attached to) the light transmissive plate 1001, and other optical structures (not shown) may be disposed therebetween. The light emitting units 1003˜1005 may be arranged into an array, and the light emitting units 1003˜1005 serve as pixel units to display an image, in which light emitted from each of the light emitting units 1003˜1005 may form a pixel of the image.

Each of the light emitting units 1003˜1005 comprises a plurality of light emitting diodes 1006˜1008 which, in this embodiment, include a plurality of visible-light light emitting diodes, i.e., red light emitting diodes, green light emitting diodes and blue light emitting diodes, and peak wavelength of the light emitted are within the visible-light range. Additionally, each of the light emitting diodes 1006˜1008 may be one or more light emitting diode chips (dies), and the material (ex. epitaxial layer) of the light emitting diodes 1006˜1008 may be nitride, gallium nitride (GaN), gallium arsenide (GaAs), gallium phosphide (GaP), silicon (Si) or the like.

As shown in FIG. 1B, the display device 10 may further comprise a control circuit 1030, which may be disposed on the substrate 1002 and electrically connected to the light emitting diodes 1006˜1008 of the light emitting units 1003˜1005. The control circuit 1030 is configured to control the light emitting diodes 1006˜1008 to emit light, that is, the control circuit 1030 can control electric power to apply to selected ones of the light emitting diodes 1006˜1008 to emit light therefrom so that those light emitting diodes can serve as light emitting elements. The control circuit 1030 is also configured to control light emission of the light emitting diodes 1006˜1008 through, for example, pulse width modulation (PWM) and control the timing at which light emitting diodes 1006˜1008 emit light so that they can emit light in turn.

When the light emitting diodes 1006˜1008 are controlled not to emit light, they may be used as light-detecting elements. That is, when any of the light emitting diodes 1006˜1008 is irradiated by light (regardless of visible light or invisible light), a corresponding electric signal can be generated by the irradiated light emitting diode by virtue of characteristics of the material of the light emitting diode. This electric signal can be received by the control circuit 1030 to determine which of the light emitting diodes 1006˜1008 of the light emitting units 1003˜1005 is irradiated by the light. In this way, any of the light emitting units 1003˜1005 can be configured to have the light receiving and detecting functions, and any of the light emitting diodes 1006˜1008 can be selected as a light receiving and detecting element. Additionally, the switching time of the light emitting diodes 1006˜1008 as light emitting elements or light-detecting elements is relatively short (i.e., the switching frequency is relatively high, e.g., up to 1 kHz), so the user will not perceive obvious flickering of the light emitting diodes 1006˜1008.

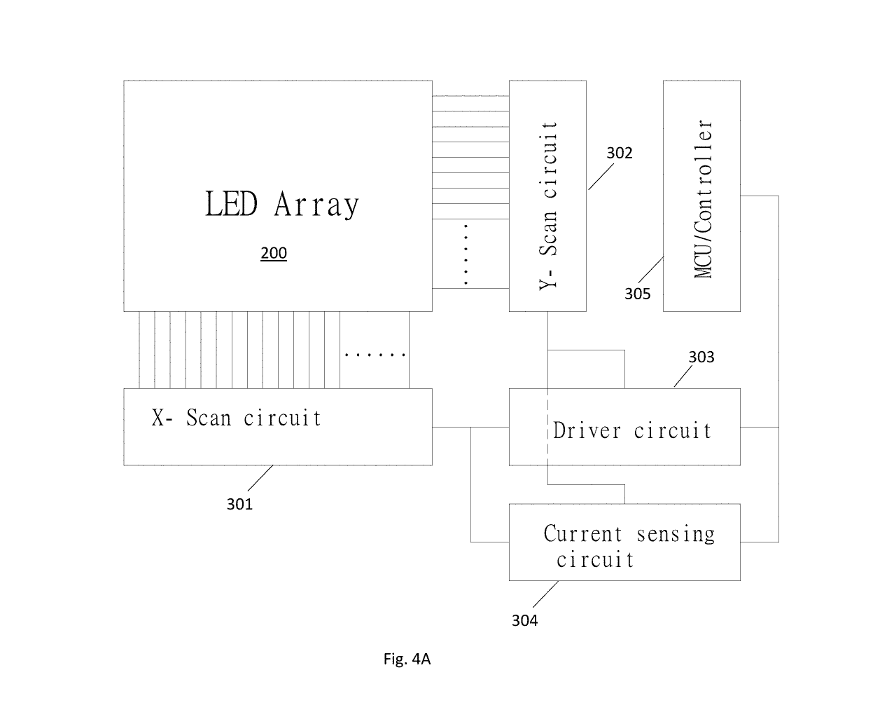

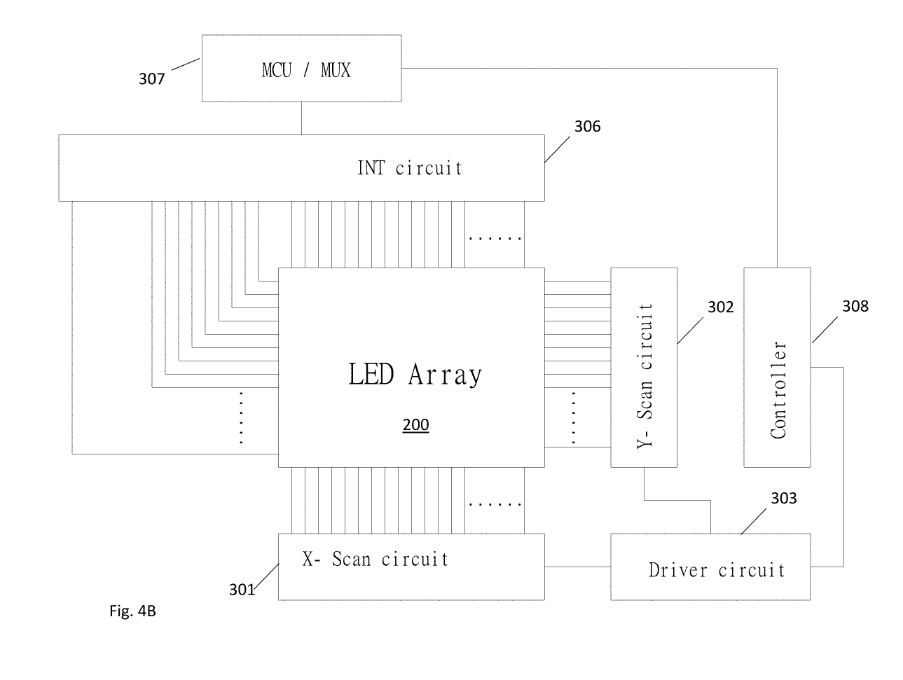

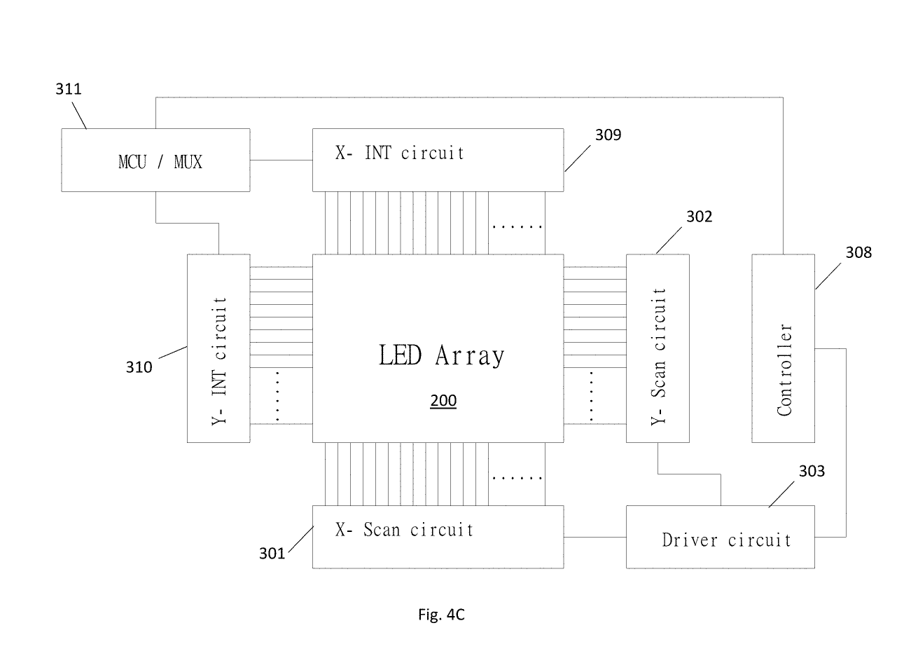

FIGS. 4A-4C schematically illustrate exemplary configurations of the control circuit 1030 and the LED array 200 according to embodiments of the present invention. In FIG. 4A, the control circuit includes an X-scan circuit 301 and a Y-scan circuit 302 connected to the LED array 200 for controlling the individual LEDs of the LED array, a driver circuit 303 connected to the X-scan circuit and the Y-scan circuit, a current sensing circuit 304 connected to the X-scan circuit and the Y-scan circuit, and a microcontroller unit (MCU) or controller 305 connected to the driver circuit 303 and the current sensing circuit 304. The driver circuit 303 controls the X-scan circuit and the Y-scan circuit to apply power to selected LEDs to control them to emit light. The current sensing circuit 304 controls the X-scan circuit and the Y-scan circuit to apply signals to selected LEDs to control the current detection, using PWM scanning. The MCU 305 controls the driver circuit 303 and the current sensing circuit 304, and can be programmed to execute the various light emitting and detecting modes described in this disclosure.

In FIG. 4B, an interrupt circuit 306 is connected to the LED array 200 to control detection of the current signal generated by the LEDs in the array. An MCU/MUX (multiplexer) 307 is connected to the interrupt circuit 306. A controller 308 is connected to the driver circuit 303 and the MCU 307. By using the driver circuit 303 to control the light emission and using the interrupt circuit 306 to control light signal detection, PWM scanning is not needed.

In FIG. 4C, instead of the interrupt circuit 306, an X interrupt circuit 309 and a Y interrupt circuit 310 are connected to the LED array 200 to control detection of the current signal generated by the LEDs in the array. The MCU/MUX 311 is connected to both the X interrupt circuit and the Y interrupt circuit. By using the driver circuit 303 to control the light emission and using the X and Y interrupt circuits 309 and 310 to control light signal detection, PWM scanning is not needed.

In the above examples, the controller 305 or 308 may be configured to process the signal detected by the current sensing circuit 304 or the interrupt circuit 306, 309 or 310 to calculate a site on the light transmissive plate where the object is touching.

The components of the control circuit 1030 are disposed on the substrate 1002.

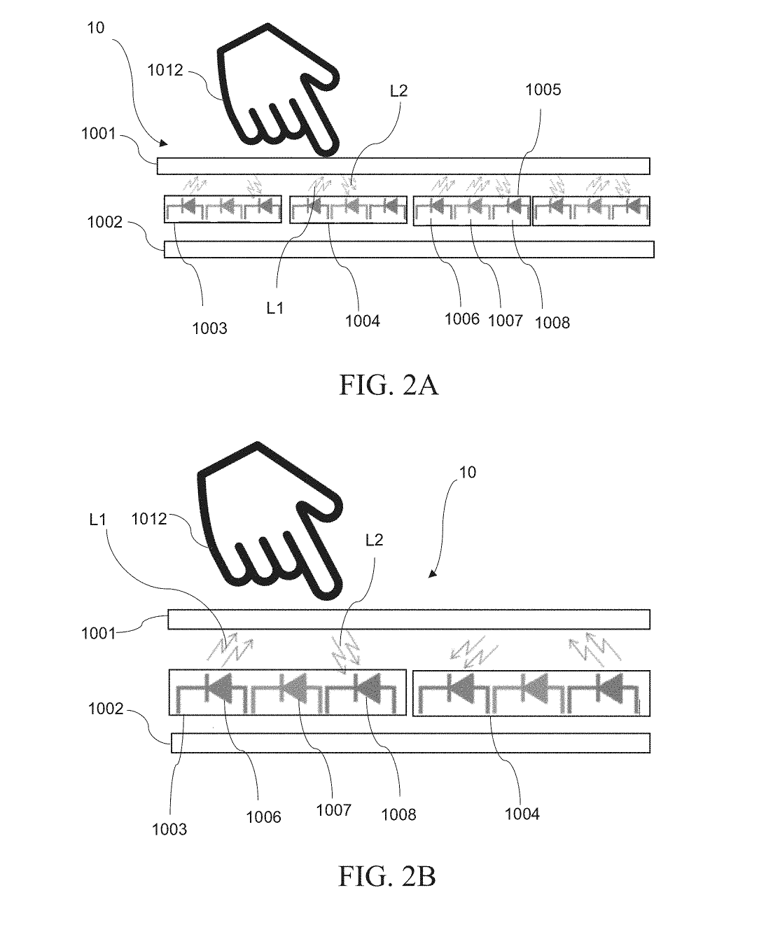

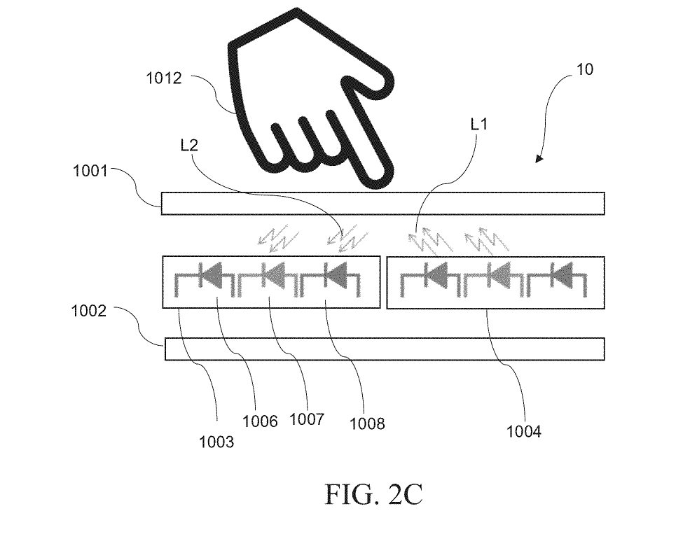

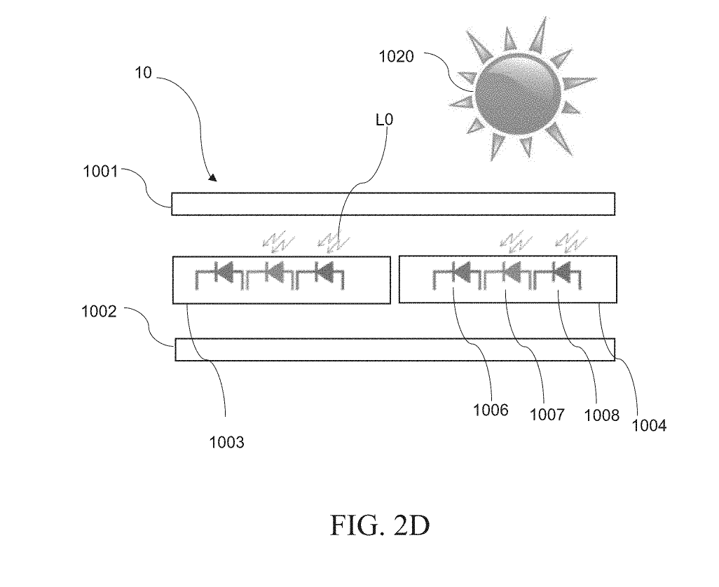

Referring to FIG. 2A, an operation mode of the light emitting diodes 1006˜1008 serving as light-detecting elements will be described next. The light emitting diodes 1006˜1008 may generate light (visible light) L1 in turn, so those of the light emitting diodes 1006˜1008 that are not emitting the light L1 are used as light-detecting elements. When an object 1012 (e.g., a finger, not limited to a conductor) touches or approaches to the light transmissive plate 1001 above one of the light emitting units 1004, the light L1 (e.g., red light or called first light) emitted from the light emitting diode 1006 is reflected by the object 1012 to the neighboring light emitting diode 1007. Because at this time the light emitting diode 1007 is being used as a light-detecting unit instead of emitting light, the light L2 (or called second light) reflected by the object 1012 can be detected by the light emitting diode 1007 to generate an electric signal. Thereby, the control circuit 1030 (FIG. 1B) or a processor (not shown, e.g., a central processing unit (CPU), a microprocessor or some other processor known in the art) electrically connected to the display device 10 can determine which of the light emitting units 1003˜1005 the object 1012 is located above (in front of), so that the position of the object 1012 on the light transmissive plate 1001 can be determined to achieve the touch function of the display device 10.

Referring to FIG. 2B, when the light L1 emitted by the light emitting diode 1006 is reflected by the object 1012 at a large reflection angle (the angle between lights L1 and L2), it is also possible that the reflected light L2 is detected by the light emitting diode 1008, which is not immediately adjacent to the light emitting diode 1006, to generate a corresponding electric signal. Referring to FIG. 2C, when the object 1012 is located between two light emitting units 1003, 1004, the light L2 resulting from reflection of the light L1, which is emitted by one of the light emitting units 1004, from the object 1012 can be detected by another light emitting unit 1005. As can be known from this, the light emitting units 1003, 1004 located at different positions can detect light from each other.

It shall also be appreciated that, the light emitting diodes 1006˜1008 can serve as light emitting elements and light-detecting elements for each other, and light emitting diodes 1007, 1008 of other colors besides the light emitting diode 1006 may also be used as light emitting elements. That is, one of the light emitting diodes (e.g., the red light emitting diode) 1006 having the longest light-emitting wavelength may be selected as the light-detecting element, or one of the light emitting diodes (e.g., the blue light emitting diode) 1008 having the shortest light-emitting wavelength may be selected as the light-detecting element, or one of the light emitting diodes (e.g., the green light emitting diode) 1007 having an intermediate light-emitting wavelength may be selected as the light-detecting element.

Referring to FIG. 2D, besides being configured to detect reflected light L2 from other ones of the light emitting diodes 1006˜1008, the light emitting diodes 1006˜1008 may also be configured to detect light L0 from a light source 1020 outside the display device 10. More specifically, when the light L0 (e.g., either visible light or invisible light) from the light source 1020 (e.g., a natural light source or an artificial light source) is irradiated to one or more positions on the light transmissive plate 1001, the light L0 can be detected by the light emitting diodes 1006˜1008 in the corresponding one of the light emitting units 1003˜1005. Thereby, the control circuit 1030 can dynamically adjust respective brightness of the light emitting units 1003˜1005 according to the brightness of the light L0 from the light source 1020 detected by the light emitting units 1003˜1005.

Furthermore, the light source 1020 may be a light source having a small spatial range of irradiation such as a laser pen. In this case, the user may control the light L0 to be irradiated to a specific position on the light transmissive plate 1001 so that the light L0 is detected by a corresponding one of the light emitting units 1003˜1005, and then a function option corresponding to this position is executed accordingly. For example, if the display device 10 is used as a display of a game machine and a shooting game is being played on the game machine, then irradiation of the light L0 to a specific position on the light transmissive plate 1001 may indicate that this specific position is being targeted by the shot, and thereby, a function option corresponding to this position is executed by the game machine.

On the other hand, the light L0 of the light source 1020 may be encoded into an optical signal and irradiated to the light transmissive plate 1001 of the display device 10. Then the optical signal is detected by the light emitting diodes 1006˜1008 serving as the light-detecting elements, and is decoded by the control circuit 1030 or an external processor. In this way, the display device 10 may have a function of optical signal transmission.

When the display device 10 is at a full black state, the display device 10 can still detect the light L0 from the light source 1020 provided externally. More specifically, the display device 10 defines a full black state, in which the light emitting units 1003˜1005 do not emit visible light, so the display device 10 is recognized by the user to be black. In this state, the light emitting diodes 1006˜1008 may all be used as light-detecting elements to detect the light L0 of the light source 1020 provided externally.

What described above are the technical contents of the display device 10, and the technical contents of other embodiments of the present invention will be described next. As for the technical contents of the individual embodiments, reference may be made to each other, so identical portions will be omitted or simplified. Moreover, the technical contents of the individual embodiments may be applied to or combined with each other.

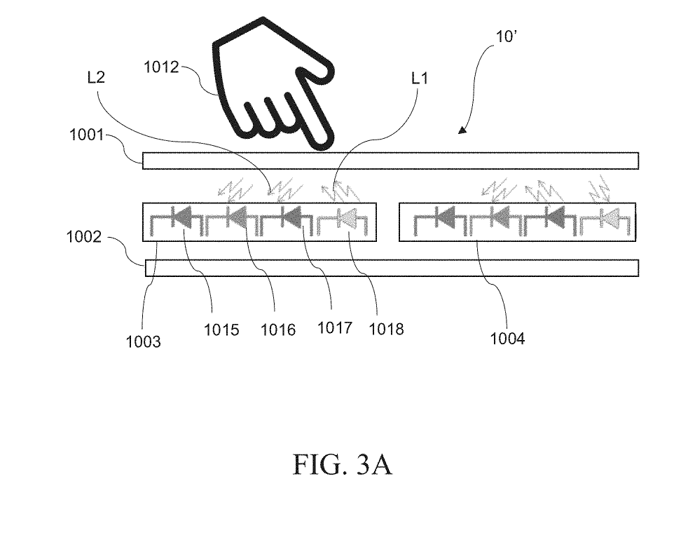

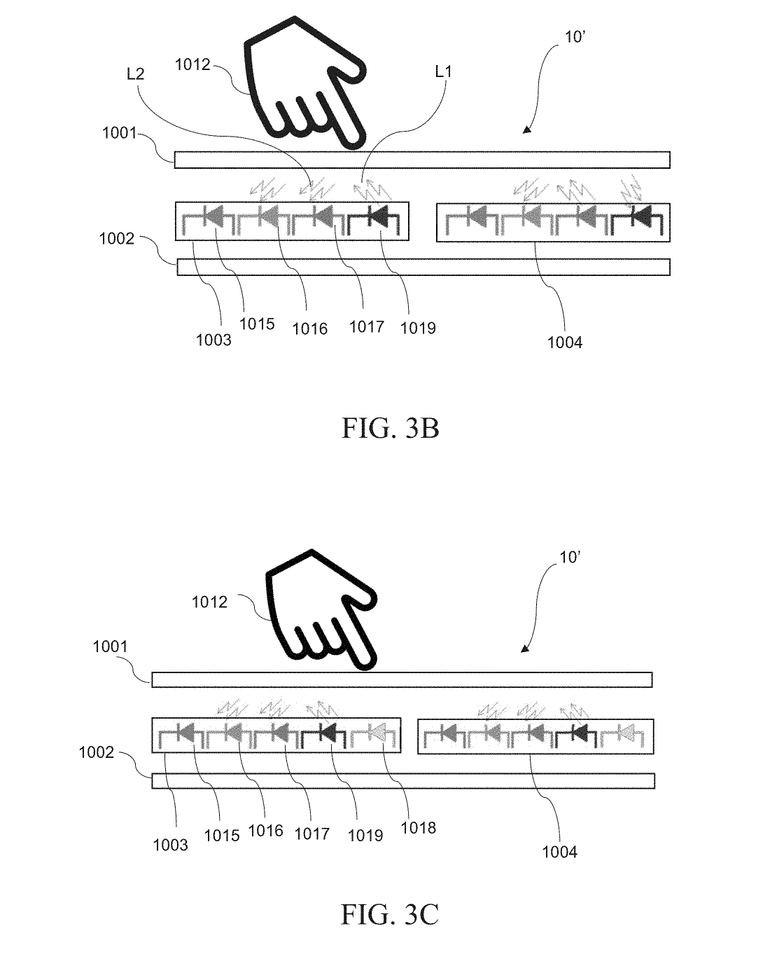

Please refer to FIGS. 3A-3C, which depict schematic views of a display device 10′ according to another preferred embodiment of the present invention. The display device 10′ also comprises a light transmissive plate 1001, a substrate 1002 and a plurality of light emitting units 1003, 1004 (taking two light emitting units as an example). In this embodiment, the light emitting units 1003, 1004 further comprise one or more invisible-light light emitting diodes 1018, 1019 in addition to the visible-light light emitting diodes 1015˜1017 (e.g., red, green and blue light emitting diodes).

More specifically, the invisible-light light emitting diodes 1018, 1019 may include infrared (i.e. IR) or ultraviolet light (i.e. UV) emitting diodes, and the light L1 emitted therefrom are invisible and thus does not contribute to image displaying. When there is an object 1012 on the light transmissive plate 1001, the light L1 is reflected and then received by other visible-light light emitting diodes 1015˜1017 or invisible-light light emitting diodes 1018, 1019. Additionally, the invisible-light light emitting diodes 1018, 1019 may also be selected as light-detecting elements to detect the light L1 emitted from the visible-light light emitting diodes 1015˜1017 or other invisible-light light emitting diodes 1018, 1019. In other words, the visible-light light emitting diodes 1015˜1017 and the invisible-light light emitting diodes 1018, 1019 may serve as light emitting elements and light-detecting elements of each other. The invisible-light light emitting diodes 1018, 1019 may also receive light L0 (e.g., FIG. 2D) from a light source 1020 provided externally. Thereby, the display device 10′ may also have the touch function, the object detection function or the signal transmission function.

On the other hand, when the display device 10 is at the full black state, the visible-light light emitting diodes 1015˜1017 do not emit light but the invisible-light light emitting diodes 1018, 1019 can still emit light L1. Therefore, when the object 1020 is located on the display device 10 that is at the full black state, the light L2 reflected by the light emitting diodes 1018, 1019 can be detected by the light emitting diodes 1015˜1017. In this way, the display device 10′ still has the touch function, the object detection function or the optical signal transmission function even at the full black state.

In another embodiment, only the invisible-light light emitting diodes 1018, 1019 are allowed to be used as light-detecting elements, while the visible-light light emitting diodes 1015˜1017 are used merely as light emitting elements to form a display image. Thereby, the control circuit 1030 can be simplified without having to switch the light emitting diodes 1015˜1017 between being used as light emitting elements and being used as light-detecting elements.

In view of the above descriptions, the display devices provided in the preferred embodiments of the present invention can use light emitting diodes as light-detecting elements to achieve such functions as the touch function, the object detection function and/or the signal transmission function no matter whether the display device is at a displaying state or a full black state. Moreover, the number of parts is not significantly increased due to implementation of these functions.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display device, comprising:
a light transmissive plate;
a substrate;
a plurality of light emitting diodes forming a plurality of light emitting units, disposed between the substrate and the light transmissive plate, and electrically connected to the substrate; and
a control circuit disposed on the substrate and electrically connected to each of the plurality of light emitting diodes,
wherein the control circuit is either configured to apply a first control signal to each of at least a subset of the light emitting diodes to emit light during at least a first time period and to apply a second control signal to each of the subset of the light emitting diodes to detect an electrical signal generated by each of the subset of the light emitting diodes in response to being irradiated by light during a second time period, or the control circuit is configured to apply a first control signal to each of at least a first subset of the light emitting diodes to emit light and at the same time to apply a second control signal to each of a second subset of the light emitting diodes to detect an electrical signal generated by each of the second subset of the light emitting diodes in response to being irradiated by light.

2. The display device according to claim 1, wherein the light emitting diodes comprise a plurality of visible-light light emitting diodes.

3. The display device according to claim 2, wherein the light emitting diodes further comprise an invisible-light light emitting diode.

4. The display device according to claim 3, wherein the invisible-light light emitting diode comprises an infrared light emitting diode or an ultraviolet light emitting diode; the visible-light light emitting diode comprises a red light emitting diode, a green light emitting diode or a blue light emitting diode.

5. The display device according to claim 3, wherein the control circuit is configured to apply the first control signal to the visible-light light emitting diode to emit a visible light and at the same time apply the second control signal to the invisible-light light emitting diode to detect the electrical signal generated by the invisible-light light emitting diode in response to being irradiated by the visible light emitted from the visible-light light emitting diode.

6. The display device according to claim 3, wherein the control circuit is configured to apply the first control signal to the invisible-light light emitting diode to emit an invisible light and at the same time apply the second control signal to the visible-light light emitting diode to detect the electrical signal generated by the visible-light light emitting diode in response to being irradiated by the invisible light emitted from the invisible-light light emitting diode.

7. The display device according to claim 2, wherein the control circuit is configured to apply the first control signal to a first visible-light light emitting diode to emit a visible light and at the same time apply the second control signal to a second visible-light light emitting diode to detect the electrical signal generated by the second visible-light light emitting diode in response to being irradiated by the visible light emitted from the first visible-light light emitting diode.

8. The display device according to claim 3, wherein the light emitting diodes further comprise an additional invisible-light light emitting diode, and the control circuit is configured to apply the first control signal to the additional invisible-light light emitting diode to emit an invisible light and at the same time apply the second control signal to the invisible-light light emitting diode to detect the electrical signal generated by the invisible-light light emitting diode in response to being irradiated by the invisible light emitted from the additional invisible-light light emitting diode.

9. The display device according to claim 3, wherein the display device defines a full black state, and the control circuit is configured to apply the first control signal to the invisible-light light emitting diode to emit an invisible light and at the same time apply the second control signal to the visible-light light emitting diode to, at the full black state, detect the electrical signal generated by the visible-light light emitting diode in response to being irradiated by the invisible light emitted from the invisible-light light emitting diode.

10. The display device according to claim 2, wherein the control circuit is configured to apply the first control signal to the plurality of light emitting diodes to detect the electrical signal generated by the light emitting diodes in response to being irradiated by visible light and/or invisible light emitted from a light source outside the display device.

11. The display device according to claim 2, wherein the display device defines a full black state, and the control circuit is configured to apply the second control signal to the plurality of light emitting diodes to, at the full black state, detect the electrical signal generated by the light emitting diode in response to being irradiated by visible light and/or invisible light emitted from a light source outside the display device.

12. The display device according to claim 2, wherein the control circuit is configured to apply the first control signal to a light emitting diode of a light emitting unit to emit a light of a first wavelength and at the same time apply the second control signal to another light emitting diode of the light emitting unit to detect the electrical signal generated by the other light emitting diode in response to being irradiated by light of a second wavelength, and wherein the second wavelength is longer than the first wavelength.

13. The display device according to claim 2, wherein the control circuit is configured to apply the first control signal to a light emitting diode of a light emitting unit to emit a light of a first wavelength and at the same time apply the second control signal to another light emitting diode of the light emitting unit to detect the electrical signal generated by the other light emitting diode in response to being irradiated by light of a second wavelength, and wherein the second wavelength is shorter than the first wavelengths.

14. The display device according to claim 2, wherein the control circuit is configured to apply the first control signal to two light emitting diodes of a light emitting unit to emit a light of a first wavelength and a light of a second wavelength, and at the same time apply the second control signal to another light emitting diode of the light emitting unit to detect the electrical signal generated by the other light emitting diode in response to being irradiated by light of a third wavelength, and wherein the third wavelength is between the first and second wavelengths.

15. The display device according to claim 1, wherein the control circuit is configured to control light emission of the light emitting diodes by using pulse width modulation.

16. The display device according to claim 1, wherein the control circuit is configured to perform a touch control function, an object detection function and/or a signal transmission function based on the electrical signals.

17. The display device according to claim 2, wherein the light transmissive plate comprises: a glass screen, a plastic screen, a sapphire screen or a flexible screen.

18. The display device according to claim 2, wherein the substrate is an opaque substrate and comprises: a printed circuit substrate, a ceramic substrate, a semiconductor substrate, a plastic substrate or a flexible substrate.

19. The display device according to claim 2, wherein material for manufacturing the light emitting diodes comprises: nitride semiconductor material, gallium nitride semiconductor material, gallium arsenide semiconductor material, gallium phosphide semiconductor material or silicone semiconductor material.

20. A display device, comprising:
a light transmissive plate;
a substrate; and
a plurality of light emitting diodes forming a plurality of light emitting units, disposed between the substrate and the light transmissive plate, and electrically connected to the substrate, wherein the light emitting diodes comprise a plurality of visible-light light emitting diodes and a plurality of invisible-light light emitting diodes.
